(19) United States
(12) Patent Application Publication
(10) Pub. No.: US 2016/0277614 A1
(43) Pub. Date: Sep. 22, 2016

(54) IMAGE FORMING SYSTEM AND INFORMATION PROCESSING APPARATUS

(71) Applicant: FUJI XEROX CO., LTD., Tokyo (JP)

(72) Inventors: Kazuya FUKUNAGA, Kanagawa (JP); Michio KIKUCHI, Kanagawa (JP); Kiyofumi AIKAWA, Kangawa (JP); Hideki MORIYA, Kanagawa (JP); Masaki HACHISUGA, Kanagawa (JP); Takashi HIRAMATSU, Kanagawa (JP)

(21) Appl. No.: 14/800,220

(22) Filed: Jul. 15, 2015

(30) Foreign Application Priority Data
Mar. 17, 2015 (JP) 2015-053817

(51) Int. Cl. G03G 15/00; G03G 21/00

(52) U.S. Cl. CPC H04N 1/00795; H04N 1/50

(57) ABSTRACT

Provided is an image forming system including one or more image forming apparatuses, each of which including an image data obtaining unit that obtains image data, and a forming unit that forms an image on a recording medium, a quality information outputting device that is provided in each of the image forming apparatuses, including an outputting unit that outputs quality information, and an information processing apparatus including a quality information obtaining unit that obtains the quality information which the outputting unit outputs, a request information obtaining unit that obtains request information, a selecting unit that selects the image forming apparatus in which the quality information outputting device which outputs the quality information satisfying the quality represented by the request information is provided, and an image data transmitter that transmits the image data to the image forming apparatus which the selecting unit selects.

### CROSS-REFERENCE TO RELATED APPLICATIONS

This application is based on and claims priority under 35 USC 119 from Japanese Patent Application No. 2015-053817 filed Mar. 17, 2015.

### BACKGROUND

### Technical Field

The present invention relates to an image forming system and an information processing apparatus.

### SUMMARY

According to an aspect of the invention, there is provided an image forming system including:

one or more image forming apparatuses, each of which including
an image data obtaining unit that obtains image data, and
a forming unit that forms an image on a recording medium, in which the image is represented by the image data obtained by the image data obtaining unit;

a quality information outputting device that is provided in each of the image forming apparatuses, including
an outputting unit that outputs quality information which represents quality of the image formed on the recording medium; and

an information processing apparatus including
a quality information obtaining unit that obtains the quality information which the outputting unit outputs,
a request information obtaining unit that obtains request information which represents quality requested by a user with respect to the images formed on the recording medium,
a selecting unit that selects the image forming apparatus in which the qualify information outputting device which outputs the quality information satisfying the quality represented by the request information is provided, and
an image data transmitter that transmits the image data to the image forming apparatus which the selecting unit selects.

### BRIEF DESCRIPTION OF THE DRAWINGS

Exemplary embodiments of the present invention will be described in detail based on the following figures, wherein;

FIG. 1 is a diagram illustrating an example of an entire configuration of an image forming system;

FIG. 2 is a diagram illustrating an example of a hardware configuration of a terminal device;

FIG. 3 is a functional block diagram illustrating an example of functions realized in the terminal device;

FIG. 4 is a diagram illustrating an example of a hardware configuration of an image forming apparatus;

FIG. 5 is a functional block diagram illustrating an example of functions realized in the image forming apparatus;

FIG. 6 is a diagram illustrating an example of a hardware configuration of an inspection device;

FIG. 7 is a functional block diagram illustrating an example of functions realized in the inspection device;

FIGS. 8A to 8C are diagrams illustrating an example of image defects and defect levels;

FIG. 9 is a diagram illustrating an example of a hardware configuration of a server apparatus;

FIG. 10 is a functional block diagram illustrating an example of functions realized in the server apparatus;

FIG. 11 is a flowchart illustrating a flow of processes performed by the terminal device;

FIG. 12 is a diagram illustrating an example of a screen displayed by the terminal device;

FIG. 13 is a diagram illustrating an example of status information and quality information obtained by the terminal device;

FIG. 14 is a diagram illustrating an example of an evaluation table; and

FIG. 15 is a diagram illustrating an example of a screen displayed by the terminal device.

### DETAILED DESCRIPTION

Entire Configuration

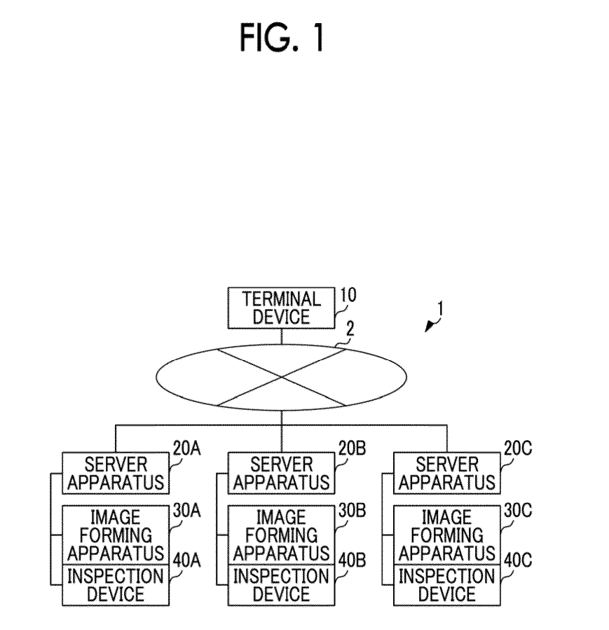

FIG. 1 is a diagram illustrating an example of an entire configuration of an image forming system 1 according to an exemplary embodiment of the invention. The image forming system 1 includes a terminal device 10, server apparatuses 20A to 20C, image forming apparatuses 30A to 30C, and inspection devices 40A to 40C (corresponding to quality information outputting devices). While one terminal device 10 is connected to a communication line 2 in FIG. 1, one or more terminal devices 10 may be connected to the communication line 2.

The terminal device 10 which is an example of an image processing device is a personal computer in the present exemplary embodiment. The terminal device 10 is connected to the communication line 2. The terminal device 10 communicates with the server apparatuses 20A to 20C that are connected to the communication line 2 and transmits and receives various information. The terminal device 10 selects one of the image forming apparatuses 30A to 30C by using the information obtained from the server apparatuses 20A to 20C and transmits an instruction message to the server apparatus to which the selected image forming apparatus is connected. The instruction message includes document data representing a document and an instruction to perform image formation.

The server apparatuses 20A to 20C are server apparatuses that have functions of a print server. The server apparatus 20A is connected to the image forming apparatus 30A and the inspection device 40A. The server apparatus 20B is connected to the image forming apparatus 30B and the inspection device 40B. The server apparatus 20C is connected to the image forming apparatus 30C and the inspection device 40C. The server apparatuses 20A to 20C, when obtaining the instruction message, obtain the document data included in the obtained message and generate a raster image of the document represented by the document data obtained. The server apparatuses 20A to 20C transmit image data of the generated raster image to the connected image forming apparatus and instruct the connected image forming apparatus to perform image formation. In addition, the server apparatuses 20A to 20C obtain status information from the connected image forming apparatus and obtain quality information from the connected inspection device. The status information represents the status of the image forming apparatus, and the quality information represents the result of inspection of the quality of an image formed by the image forming apparatus. The server apparatuses 20A to 20C transmit the quality information obtained and the status information obtained to the terminal device 10. While the server apparatuses 20A to 20C are illustrated in FIG. 1, the number of server apparatuses connected to the communication line 2 is not limited to three. One or more image forming apparatuses and/or inspection devices may be managed by one server apparatus.

The image forming apparatuses 30A to 30C are apparatuses that obtain the image data from the connected server apparatus and form an image on a piece of paper which is an example of a recording medium. While the image forming apparatuses 30A to 30C form an image on a piece or paper through the electrophotographic process in the present exemplary embodiment, the image forming apparatuses 30A to 30C may be configured to use ink to form an image on a piece of paper. The inspection device 40A is connected to the image forming apparatus 30A. The inspection device 40B is connected to the image forming apparatus 30B. The inspection device 40C is connected to the image forming apparatus 30C. The recording medium on which an image is formed by the image forming apparatus 30A is transported to the inspection device 40A. The recording medium on which an image is formed by the image forming apparatus 30B is transported to the inspection device 40B. The recording medium on which an image is formed by the image forming apparatus 30C is transported to the inspection device 40C. The image forming apparatuses 30A to 30C transmit the status information representing the status thereof to the connected server apparatus.

The inspection devices 40A to 40C are devices that obtain the recording medium transported from the connected image forming apparatus and inspect the quality of the image formed on the obtained recording medium. The inspection devices 40A to 40C, when inspecting the quality of the image formed on the recording medium, transmit the quality information representing the result of inspection of the quality to the connected server apparatus. An accommodation unit (not illustrated) that accommodates the recording medium is connected to each of the inspection devices 40A to 40C. The inspection devices 40A to 40C transport the recording medium of which inspection is finished to the connected accommodation unit. Specific examples of the accommodation unit include a type such as a stacker in which the recording medium is accommodated and a type such as a tray on which the recording medium is stacked.

Configuration of Terminal Device 10

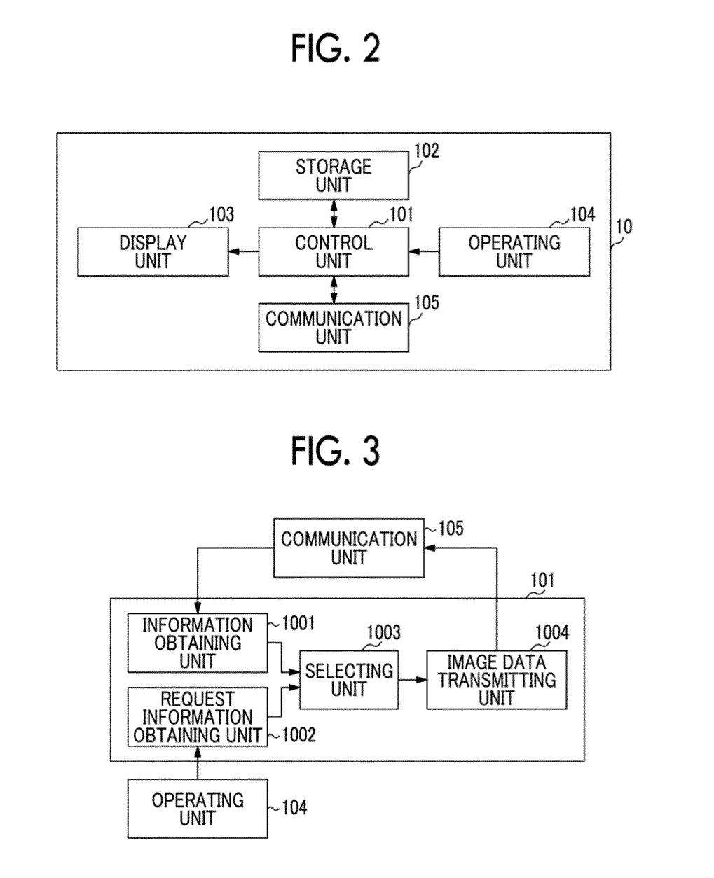

FIG. 2 is a diagram illustrating an example of a hardware configuration of the terminal device 10. A display unit 103 is provided with a display device. The display unit 103 displays various screens so as to operate the terminal device 10. An operating unit 104 includes input devices such as a keyboard and a mouse so as to operate the terminal device 10. A communication unit 105 is connected to the communication line 2 and functions as a communication interface that performs data communication through the communication line 2. A control unit 101 is provided with a central processing unit (CPU) and a random access memory (BAM) and executes a program stored on a storage unit 102.

The storage unit 102 includes a device that permanently stores data (for example, a hard dish device) and stores programs of an operating system and application programs. In the present exemplary embodiment, the storage unit 102 stores an application program (hereinafter, referred to as a first application) that realizes functions of desktop publishing (DTP). The control unit 101 that executes the first application creates a document including sentences, pictures, and figures according to an operation by a user. The document data representing the created document is stored on the storage unit 102. In addition, the storage unit 102 stores an application program (hereinafter, a second application) that realizes the function of selecting the image forming apparatus from the image forming apparatuses 30A to 30C which is to form the image of the document represented by the document data on the recording medium. The control unit 101, when executing the second application, selects the image forming apparatus, which is to form the image of the document on the recording medium, by using the information that a user inputs into the operating unit 104, the status information and the quality information obtained from the server apparatus 20, and the like and transmits the instruction message to the selected image forming apparatus.

Functional Configuration of Terminal Device 10

FIG. 3 is a functional block diagram relevant to the functions realized by execution of the second application.

An information obtaining unit 1001 obtains the status information and the quality information from the server apparatus 20. The information obtaining unit 1001 is an example of a quality information obtaining unit that obtains the quality information.

A request information obtaining unit 1002 displays a GUI so as to receive input of a request of a user for the image of the document formed on the recording medium and obtains the request that is input on the GUI. The request information obtaining unit 1002 is an example of a request information obtaining unit.

A selecting unit 1003 is an example of a selecting unit that selects the image forming apparatus in which the inspection device which outputs the quality information satisfying the quality represented by the request information is disposed.

An image data transmitting unit 1004 transmits the document data to the server apparatus to which the image forming apparatus selected by the selecting unit 1003 is connected. The document data is an example of image data that represents the image formed on the recording medium. The image data transmitting unit that transmits the document data is an example of an imago data transmitter that transmits the image data.

Hardware Configuration of Image Forming Apparatuses 30A to 30C

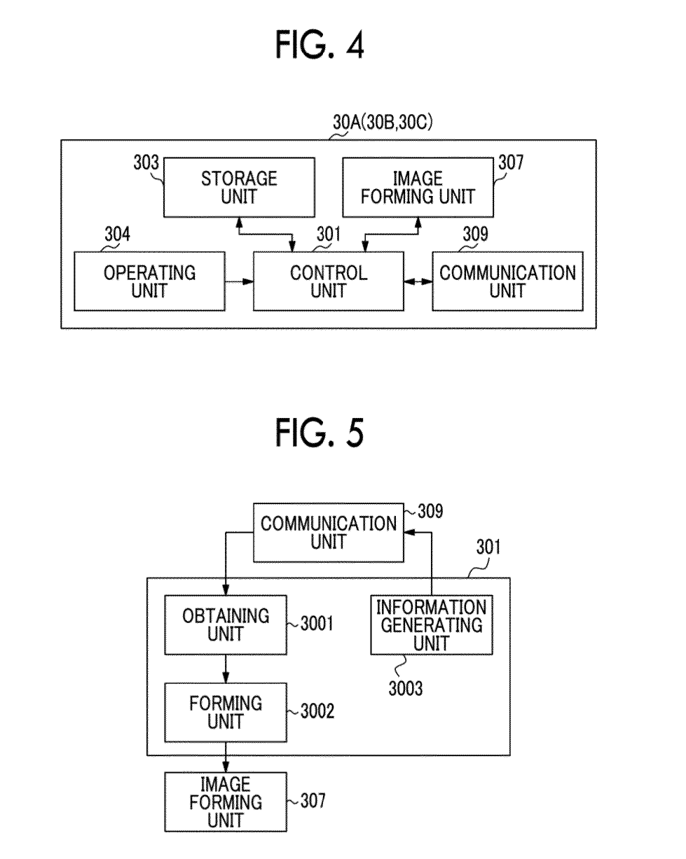

FIG. 4 is a block diagram illustrating an example of a hardware configuration of the image forming apparatuses 30A to 30C according to the present exemplary embodiment. An operating unit 304 is provided with one or more buttons and a touch panel so as to operate the image forming apparatus. A communication unit 309 is connected to the server apparatus and functions as a communication interface that performs data communication with the connected server apparatus.

An image forming unit 307 forms a toner image on the recording medium, through the electrophotographic process. Specifically, the image forming unit 307 is provided with an image forming unit that forms a yellow color toner image, an image forming unit that forms a magenta color toner image, an image forming unit that forms a cyan color toner image, and an image forming unit that forms a black color toner image. Each image forming unit, after forming an electrostatic latent image on a photoconductor according to the image data obtained by the communication unit 309, forms a toner image in each color by attaching toner to the surface of the photoconductor and transfers the toner image onto the recording medium. Each image forming unit fixes the toner image to the recording medium by applying heat and pressure to the toner image transferred onto the recording medium and transports the recording medium on which the toner image is formed to the connected inspection device.

A control unit 301 is provided with a CPU and a RAM and executes programs stored on a storage unit 303. The storage unit 303 includes a storage device that permanently stores data (for example, a hard disk device). The storage unit 303 stores a program that realizes the function of forming an image on the recording medium, the function of transmitting the status information representing the status of the image forming apparatus to the connected server apparatus, and the like.

Functional Configuration of Image Forming Apparatuses 30A to 30C

FIG. 5 is a functional block diagram relevant to the functions that are realized by executing the program stored on the storage unit 303. An obtaining unit 3001 is an example of an image data obtaining unit and obtains the image data of the raster image transmitted from the server apparatus. A forming unit 3002 supplies the image data obtained by the obtaining unit 3001 to the image forming unit 307 and performs a process of controlling the image forming unit 307 and forming an image on the recording medium. The forming unit 3002 and the image forming unit 307 that cooperate with each other to form an image on the recording medium are examples of a forming unit that forms an image on the recording medium. An information generating unit 3003 generates the status information that represents the status of the image forming apparatus. The status information includes information of, for example, the size and type of the recording medium on which the image forming apparatus forms an image. The status information generated by the information generating unit 3003 is transmitted by the communication unit 309 to the server apparatus to which the image forming apparatus is connected.

Hardware Configuration of Inspection Devices 40A to 40C

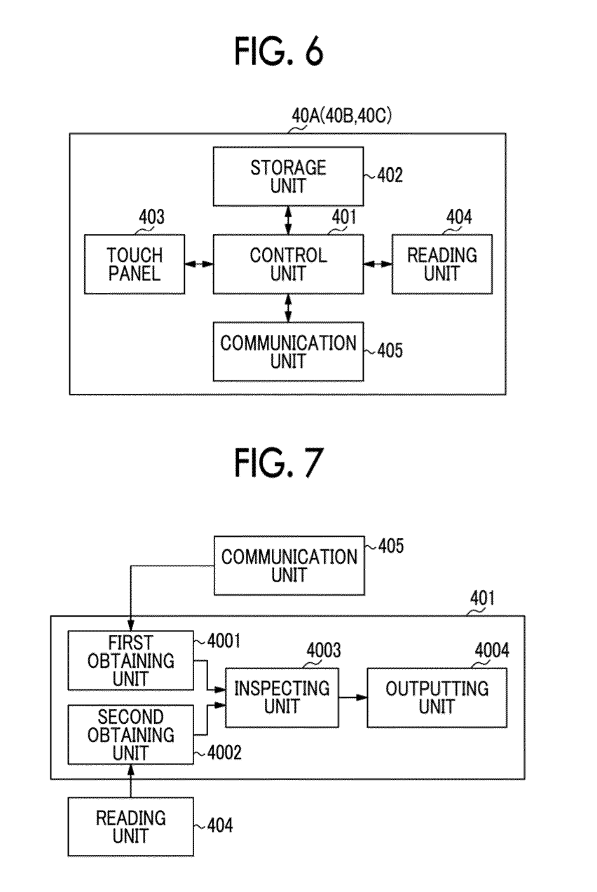

FIG. 6 is a block diagram illustrating a hardware configuration of the inspection devices 40A to 40C. A touch panel 403 is a device that is a combination of a display device (for example, a liquid crystal display) and a sensor which detects contact of a finger with a display face of the display device. The touch panel 403 is an example of an operator unit that is operated by a user. The touch panel 403 displays a graphical user interface (GUI) or the like so as to operate the inspection device. In addition, the touch panel 403 detects with the sensor the position that a user contacts with a finger. A control unit 401 specifies an operation of a user according to the position detected by the touch panel 403 and the screen displayed on the touch panel and performs control of each unit and various processes according to the specified operation.

A communication unit 405 is connected to the server apparatus and functions as a communication interface that performs data communication with the connected server apparatus. A reading unit 404 optically reads the image on the recording medium transported from the connected image forming apparatus and generates image data that represents the read image. The reading unit 404 is an example of a reading unit that reads the image formed on the recording medium. The reading unit 404 outputs the generated image data to the control unit 401.

The control unit 401 is provided with a CPU and a RAM and executes programs stored on a storage unit 402. The storage unit 402 includes a storage device that permanently stores data (for example, a hard disk device) and stores a program that realizes the function of inspecting the recording medium transported from the image forming apparatus, the function of transmitting an inspection result to the server apparatus, and the like.

Functional Configuration of Inspection Devices 40A to 40C

FIG. 7 is a functional block diagram relevant to the functions that are realized by executing the program stored on the storage unit 402. A first obtaining unit 4001 obtains image data transmitted from the server apparatus. The image data is the image data of the raster image that the server apparatus transmits to the connected image forming apparatus. That is, the image data is data that is the base of the image read by the reading unit 404 and formed on the recording medium. A second obtaining unit 4002 obtains the image data generated by the reading unit 404.

An inspecting unit 4003 inspects the quality of the image that the reading unit 404 reads from the recording medium by using the image data obtained by the first obtaining unit 4001 and the image data obtained by the second obtaining unit 4002. The inspecting unit 4003 is an example of an inspector that inspects the quality of the image formed on the recording medium. The inspection is performed each time the first obtaining unit 4001 and the second obtaining unit 4002 obtain new data.

The inspecting unit 4003, for example, inspects the color difference between the color of the raster image and the color of the image formed on the recording medium. The inspecting unit 4003, when determining that there is a color difference, obtains a color difference ΔE that is the distance between the color of the raster image in the color space of the L*a*b* color model and the color of the image read from the recording medium at a predetermined position in the image.

The inspecting unit 4003 inspects defects of the image formed on the recording medium. The inspecting unit 4003, when inspecting image defects, inspects, for example, image loss, image blur, and image addition (means there is an image in the read image that is not present in the raster image, such as black points having an area larger than or equal to a threshold and black points having a length greater than or equal to a threshold) as examples of image defects.

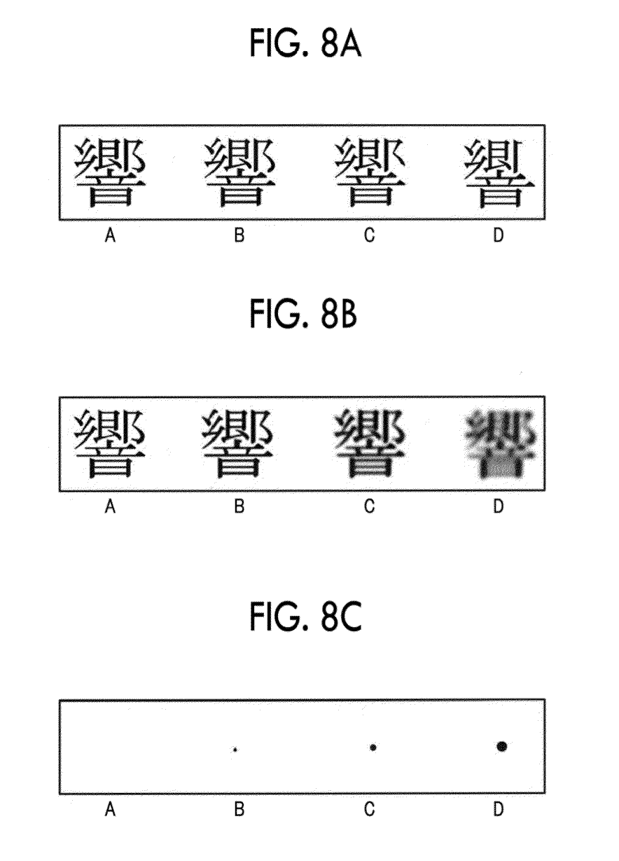

The inspecting unit 4003 determines the area of the part of the read image where an image is lost from the raster image. For example, the inspecting unit 4003 determines the level of image loss as a level A when the area of the lost part is less than a predetermined threshold as illustrated in FIG. 8A. In addition, the inspecting unit 4003 presets one or more thresholds and determines the level of image loss as a level B, a level C, or a level D as the area of the lost part becomes larger.

The inspecting unit 4003, regarding image blur, for example, performs edge detection on the read image and compares the positions of edges with those in the raster image. As illustrated in FIG. 8B, when an edge in the read image is present at the same position as that in the raster image, the inspecting unit 4003 determines the level of image blur as a level A. The inspecting unit 4003 determines the level of image blur as a level B, a level C, or a level D as the position of an edge in the read image is more separated from that in the raster image.

The inspecting unit 4003, regarding image addition, compares the read image with the raster image and determines the area of the part of the read image that is not present in the raster image. For example, the inspecting unit 4003 determines the level of image addition as a level A when the area of the part of the read image that is not present in the raster image is less than a predetermined threshold as illustrated in FIG. 8C. In addition, the inspecting unit 4003 presets one or more thresholds and determines the level of image addition as a level B, a level C, or a level D as the area of the additional part is larger.

An outputting unit 4004 is an example of an outputting unit that outputs the quality information. The outputting unit 4004 transmits the quality information representing an inspection result of the inspecting unit 4003 to the server apparatus to which the inspection device is connected by controlling the communication unit 405.

Configuration of Server Apparatuses 20A to 20C

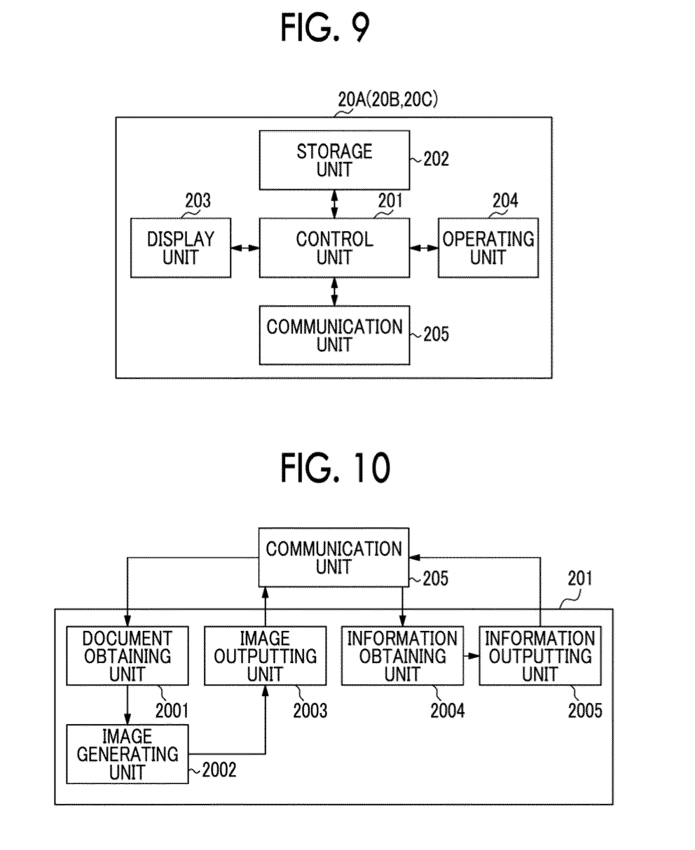

FIG. 9 is a block diagram illustrating a hardware configuration of the server apparatuses 20A to 20C. A display unit 203 is provided with a display device. The display unit 203 displays various screens so as to operate the server apparatus. An operating unit 204 includes input devices such as a keyboard and a mouse so as to operate the server apparatus. A communication unit 205 is connected to the communication line 2 and functions as a communication interface that performs data communication through the communication line 2. A control unit 201 is provided with a CPU and a RAM and executes programs stored on a storage unit 202.

The storage unit 202 includes a device that permanently stores data (for example, at hard disk device) and stores a program that realizes functions of a print server. Functions of a print server are realized when the control unit 201 executes the program stored on the storage unit 202.

In addition, when the control unit 201 executes the program stored on the storage unit 202, the function of obtaining the quality information transmitted from the inspection device and storing the obtained quality information, the function of obtaining the status information from the connected image forming apparatus, the function of transmitting the status information and the quality information to the terminal device 10, and the like are realized.

Functional Configuration of Server Apparatus 20

FIG. 10 is a functional block diagram relevant to the functions that are realized by executing the program stored on the storage unit 202. A document obtaining unit 2001 obtains the document data transmitted from the terminal device 19. An image generating unit 2002 generates the raster image of the document represented by the document data that the document obtaining unit 2001 obtains. An image outputting unit 2003 transmits the image data of the raster image generated by the image generating unit 3002 to the image forming apparatus and the inspection device that are connected to the server apparatus. An information obtaining unit 2004 obtains the status information transmitted from the image forming apparatus connected to the server apparatus and the quality information transmitted from the inspection device connected to the server apparatus. An information outputting unit 2005 transmits an identifier (for example, an IP address) of the connected image forming apparatus, an identifier (for example, an IP address) of the server apparatus, the status information obtained by the information obtaining unit 2004, the quality information obtained by the information obtaining unit 2004, and the like to the terminal device 10.

Operational Example of Exemplary Embodiment

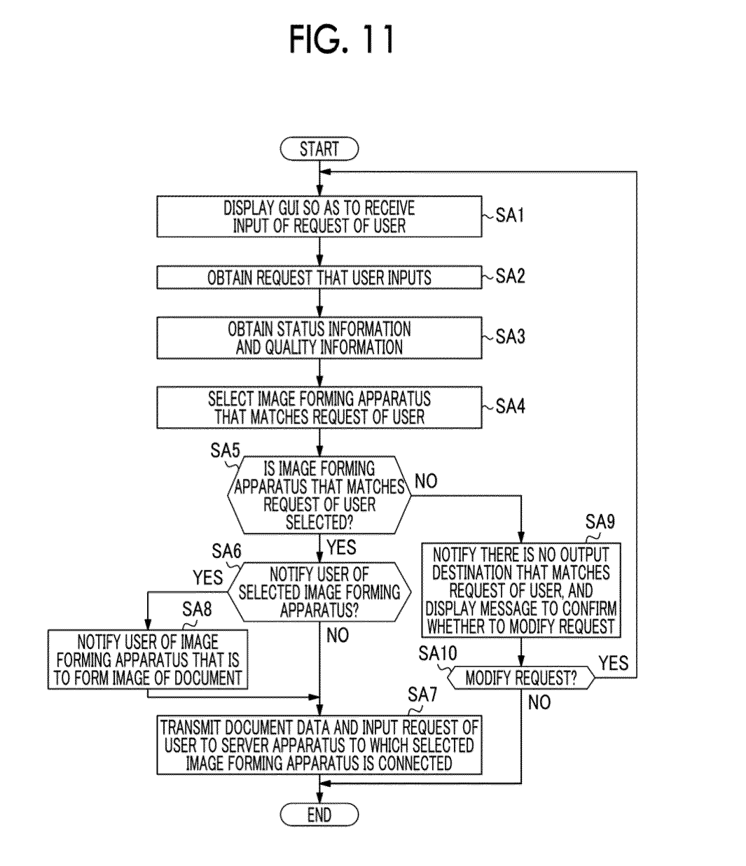

Next, a description will be provided of an example of an operational example at the time of forming the image of the document represented by the document data on the recording medium in the present exemplary embodiment. First, the control unit 101 launches the second application when a user of the terminal device 10 performs on the operating unit 104 an operation of instructing the terminal device 10 to execute the second application. The control unit 101 that launches the second application controls the display unit 103 to display a GUI for selecting the document data that represents the image of the document to be formed on the recording medium. Next, the control unit 101 performs the processes of the flowchart illustrated in FIG. 11 when the user performs an operation of selecting the document data on the displayed GUI.

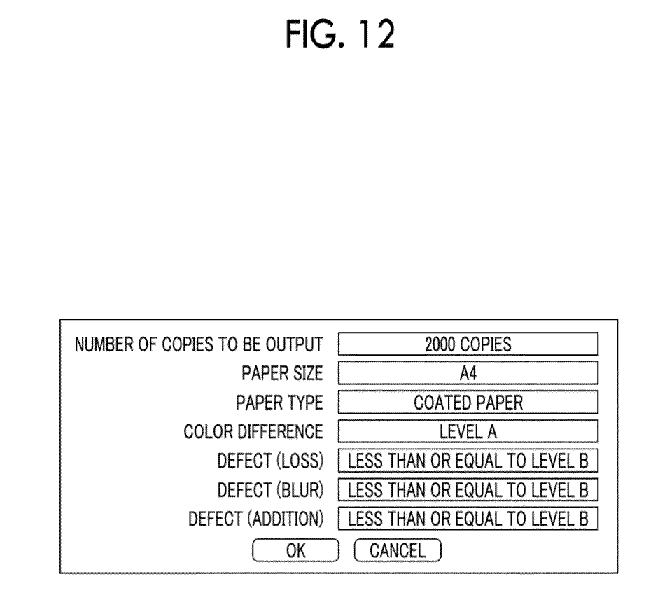

Specifically, the control unit 101 first controls the display unit 103 to display, for example, the screen illustrated in FIG. 12 as the GUI for receiving input of a request of the user for the image of the document to be formed on the recording medium (step SA1).

In the present exemplary embodiment, the user is capable of setting the number of copies of the document to be output, a paper size, a paper type, a color difference level, and a defect level on the GUI illustrated in FIG. 12 when forming the image of the document.

In the present exemplary embodiment, the color difference in the screen of FIG. 12 for the image of the document to be formed is set to the “level A” when, for example, the user wants to set the color difference ΔE between the image represented by the document data and the image to be formed on the recording medium by the image forming apparatus to ΔE<1. In addition, in the present exemplary embodiment, the levels of image loss, image blur, and image addition in the screen of FIG. 12 for the image of the document to be formed are set to “less than or equal to the level B” when the user wants to set each level of image loss, image blur, and image addition in the image to be formed on the recording medium to be less than or equal to the level B.

The user performs an operation of clicking the “OK” button illustrated in FIG. 12 when finishing settings on the screen illustrated in FIG. 12 and instructing the terminal device 10 to output the document. The control unit 101 performs a process of selecting the image forming apparatus that forms the image represented by the document data when the user performs an operation of clicking the “OK” button illustrated in FIG. 12.

Specifically, the control unit 101 first obtains the request (the number of copies to be output, a paper size, a paper type, a color difference level, and a defect level) that the user inputs on the screen of FIG. 12 (step SA2). Next, the control unit 101 communicates with the server apparatuses 20A to 20C and obtains the IP address of the image forming apparatus connected to the server apparatus, the status information that the server apparatus obtains from the image forming apparatus, and the quality information that the server apparatus obtains from the inspection device (step SA3).

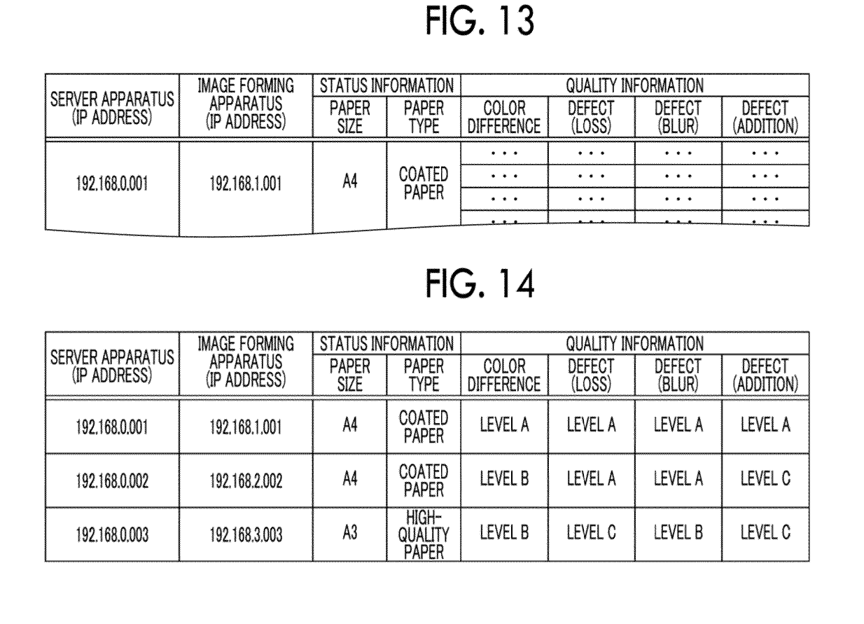

FIG. 13 is a diagram illustrating an example of an information table in which the IP address of the image forming apparatus 30A, the status information of the image forming apparatus 30A, and the quality information that the server apparatus 20A obtains from the inspection device 40A, all of which are obtained by the control unit 101 from the server apparatus 20A in step SA3, are stored. The control unit 101, as illustrated in FIG. 13, associates the information obtained from the communicating server apparatus with the IP address of the communicating server apparatus and stores the associated information and the IP address. Although an illustration is not provided, the control unit 101 also associates the information obtained from the server apparatus 20B and the information obtained from the server apparatus 20C with the IP address of the communicating server apparatus and stores the associated pieces of information as in FIG. 13.

The control unit 101, when finishing the process of step SA3, selects the image forming apparatus that matches the input request of the user by using the information obtained in step SA3 (step SA4). Specifically, the control unit 101 first evaluates the quality of the image that the image forming apparatuses 30A to 30C form by using the quality information obtained in step SA3.

The control unit 101 obtains the average value of the color difference ΔE obtained, in step SA3 and evaluates a color difference level in four stages for each image forming apparatus from the average value of the color difference ΔE obtained. For example, the control unit 101 evaluates a color difference level as a level A in the case of “average value of ΔE<1”, evaluates a color difference level as a level B in the case of “1≦average value of ΔE<2”, evaluates a color difference level as a level C in the case of “2≦average value of ΔE<3”, and evaluates a color difference level as a level D in the case of “3≦average value of ΔE”. In addition, the control unit 101 evaluates the levels of image loss, image blur, and image addition for each image forming apparatus by referring to the quality Information obtained in step SA3 and, for example, sets the levels of image loss, image blur, and image addition of the image forming apparatus as the worst levels.

A method for evaluating quality is not limited to the above method. Other methods may be used for evaluation. For example, regarding image loss, when one or more pieces of quality information are obtained from the image forming apparatus, the number of each of the level A to the level D is counted, and the level of which the counted number is the highest may be set as the level of image loss of the image forming apparatus. Other image defects may be evaluated in the same manner as image loss.

The control unit 101, when evaluating the quality of the image that the image forming apparatuses 30A to 30C form, generates an evaluation table that stores an evaluation result. FIG. 14 is a diagram illustrating an example of the evaluation table. One record of the evaluation table stores the IP address of the server apparatus, the IP address of the image forming apparatus connected to the server apparatus, the status information of the image forming apparatus connected to the server apparatus, and the result of evaluation of the quality of the image formed by the image forming apparatus connected to the server apparatus.

In FIG. 14, the information stored in the first record is an example of the status in formation of the image forming apparatus 30A connected to the server apparatus 20A and the result of evaluation of the quality of the image formed by the image forming apparatus 30A. The information stored in the second record is an example of the status information of the image forming apparatus 30B connected to the server apparatus 20B and the result of evaluation of the quality of the image formed by the image forming apparatus 30B. The information stored in the third record is an example of the status information of the image forming apparatus 30C connected to the server apparatus 20C and the result of evaluation of the quality of the image formed by the image forming apparatus 30C.

Next, the control unit 101 selects the image forming apparatus that matches the request of the user by referring to the status information in the evaluation table. When, for example, the request of the user is as illustrated in FIG. 12, and the status information obtained from the server apparatuses 20A to 20C is as illustrated in FIG. 14, the paper size requested by the user is “A4”, and the paper type is “coated paper”. Thus, it is determined that the image forming apparatus 30C that has an IP address of “192.168.3.003” and uses A3-size high-quality paper does not match the input request of the user, and the image forming apparatus 30A that has an IP address of “192.168.1.001” and uses A4-size coated paper and the image forming apparatus 30B that has an IP address of “192.168.2.002” and uses A4-size coated paper are selected as the image forming apparatus that may match the input request of the user.

Next, the control unit 101 refers to the result of evaluation of the quality of the image formed by the image forming apparatus and selects the image forming apparatus that matches the request of the user from the image forming apparatuses which are selected by using the status information. When the request of the user is as illustrated in FIG. 12, and the result of evaluation of the quality of the image formed by the image forming apparatuses 30A to 30C is as illustrated in FIG. 14, since the color difference level requested by the user is the level A, it is determined that the image forming apparatus 30B that has a color difference level of the level B and has an IP address of “192.168.2.002” does not match the input request of the user, and the image forming apparatus 30A that has a color difference level of the level A and has an IP address of “192.168.1.001” is selected as the image forming apparatus that may match the input request of the user.

Next, the control unit 101 determines whether the image forming apparatus 30A having a color difference level that matches the request of the user has levels of image loss, image blur, and image addition that match the request of the user. As illustrated in FIG. 14, all of the levels of image loss, image blur, and image addition of the image forming apparatus 30A having an IP address of “192.160.1.001” are the level A. Thus, the image forming apparatus 30A is selected as the image forming apparatus that matches the input request of the user.

The control unit 101, when finishing the process of step SA4, determines whether the image forming apparatus that matches the request of the user is selected (step SA5). The control unit 101, when the image forming apparatus that matches the request of the user is selected (YES in step SA5), determines whether notification of the selected image forming apparatus to the user is set (step SA6). The control unit 101, when notification of the selected image forming apparatus to the user is not set (NO in step SA6), transmits the document data selected by the user to the server apparatus to which the image forming apparatus selected in step SA4 is connected (step SA7).

Meanwhile, the control unit 101, when notification of the selected image forming apparatus to the user is set (YES in step SA6), notifies the user of the image forming apparatus that is selected as the apparatus which is to form the image of the document on the recording medium (step SA8). The control unit 101 controls the display unit 103 so that, for example, the IP address of the image forming apparatus selected in step SA4 and a message notifying that the image forming apparatus having the IP address is selected as the image forming apparatus that is to form the image of the document are displayed.

The control unit 101, when finishing the process of step SA8, causes the flow of processes to transition to step SA7 and transmits the document data selected by the user to the server apparatus to which the image forming apparatus selected in step SA4 is connected (step SA7).

In step SA7, as described above, when the image forming apparatus 30A is selected as the image forming apparatus that matches the request of the user, the control unit 101 obtains the IP address of the server apparatus 20A that is stored in association with the address such as the IP address or a computer name of the image forming apparatus 30A in the evaluation table and transmits to the obtained IP address as a destination the instruction message that includes the document data selected by the user and the request information representing the input request of the user and that instructs the server apparatus 20A to perform image formation.

The server apparatus 20A obtains the document data and the request information that are included in the instruction message transmitted from the terminal device 10. The server apparatus 20A generates the raster image of the document that the obtained document data represents. The server apparatus 20A, when finishing generating the raster image, transmits the image data of the generated raster image and the request information to the connected image forming apparatus 30A and instructs the image forming apparatus 30A to perform image formation. In addition, the server apparatus 20A transmits the generated raster image to the connected inspection device 40A.

The image forming apparatus 30A obtains the image data of the raster image and the request information. The image forming apparatus 30A forms the image represented by the raster image on a piece of paper having the paper size and the paper type represented by the request information so that the number of copies of the raster image represented by the obtained request information are output.

The inspection device 40A obtains the raster image that the server apparatus 20A transmits. The inspection device 40A, when the recording medium on which the image of the document is formed is transported from the image forming apparatus 30A, inspects the recording medium for whether the image formed on the recording medium is the same as the raster image obtained. The inspection device 40A transmits the quality information that represents the result of inspection of the quality of the image formed on the recording medium to the server apparatus 20A.

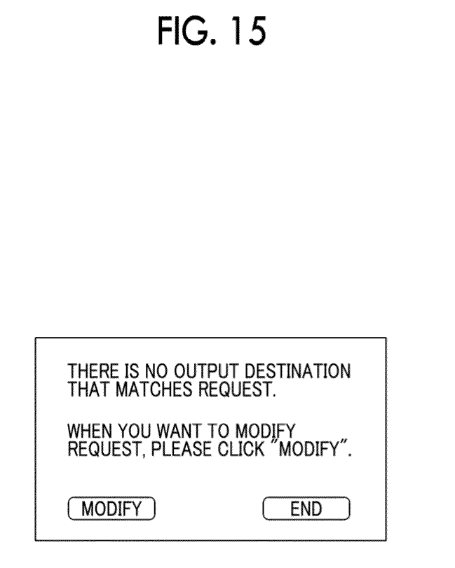

The control unit 101, when there is no image forming apparatus that matches the request of the user, and the image forming apparatus that matches the request of the user is not selected in step SA4 (NO in step SA5), notifies the absence of the image forming apparatus that matches the request of the user and controls the display unit 103 so as to display a message (FIG. 15) that allows the user to confirm whether to modify the request (step SA9).

When the user who sees the screen of FIG. 15 performs an operation of clicking the “modify” button displayed (YES in step SA10), the control unit 101 causes the flow of processes to return to step SA1. When the user who sees the screen of FIG. 15 performs an operation of clicking the “end” button displayed (NO in step SA10), the control unit 101 ends the processes of the flowchart illustrated in FIG. 11 without transmitting the document data to the server apparatus.

As described thus far, according to the present exemplary embodiment, the image forming apparatus that performs image formation in the quality matching the request of the user such as a color difference and image defects is selected from one or more image forming apparatuses, and image formation is performed by the selected image forming apparatus.

### MODIFICATION EXAMPLE

While the exemplary embodiment of the invention is described thus far, the invention is not limited to the above exemplary embodiment and may be embodied in various other forms. For example, the invention may be embodied by modifying the above exemplary embodiment as follows. The exemplary embodiment described above and a modification example described below may be combined with each other.

In the exemplary embodiment above, the server apparatus obtains the quality information from the connected image forming apparatus. However, when, for example, a newly shipped image forming apparatus is connected to the server apparatus, for example, data of a raster image of a test image is transmitted from the server apparatus to the image forming apparatus and the inspection device. The inspection device inspects the test image and transmits the quality information to the server apparatus, and the server apparatus obtains and stores the quality information relevant to the test image.

According to this configuration, even if a newly shipped image forming apparatus is connected to the server apparatus, the newly connected image forming apparatus becomes a candidate for the image forming apparatus that matches the input request of the user because the quality information is stored on the server apparatus.

In addition, when a component relevant to image formation is replaced in the connected image forming apparatus, the quality information of the image forming apparatus in which the component is replaced is deleted from the quality information stored on the server apparatus, and the data of the raster image of the test image is transmitted from the server apparatus to the image forming apparatus and the inspection device. The inspection device inspects the test image and transmits the quality information to the server apparatus, and the server apparatus obtains and stores the quality information relevant to the test image.

According to this configuration, the quality information of the image formed by the image forming apparatus in which the component is replaced is newly stored on the server apparatus, and the terminal device 10 selects the image forming apparatus that is to form the image of the document by using the newly stored quality information.

In the exemplary embodiment above, when there is no image forming apparatus that matches the request of the user, the absence of the image forming apparatus that matches the request of the user is notified to the user. However, a specific item that does not match the request of the user may be notified to the user. For example, when there is no image forming apparatus that performs image formation at a color difference level requested by the user, the terminal device 10 notifies the user that there is no image forming apparatus that matches the request of the user regarding the color difference level. According to this configuration, the user notices which part of the request is to be modified to output the document from the image forming apparatus.

In addition, when there is no image forming apparatus that matches the request of the user, a list of image forming apparatuses may be displayed in order from the image forming apparatus having the greatest number of matched items in the request of the user.

In the exemplary embodiment above, when there are one or more image forming apparatuses that match the request of the user, the terminal device 10 may display a list of image forming apparatuses that match the request of the user and may allow the user to select the image forming apparatus from the list.

In addition, one image forming apparatus may be selected from one or more image forming apparatuses according to a predetermined rule. For example, the number of recording media on which the image forming apparatus performs image formation may be obtained as the status information, and the image forming apparatus that performs image formation on a small number of recording media may be selected.

In the exemplary embodiment above, the inspection device may count the number of recording media inspected, associate the counted number with the quality information, and transmit the associated counted number and the quality information to the server apparatus, and the server apparatus may associate the number transmitted from the inspection device with the quality information and store the associated number and the quality information.

In the image forming apparatus, the color difference between the raster image obtained and the image formed on the recording medium may increase due to temporal change of components. According to this configuration, the information of the number of recording media on which the image forming apparatus performs image formation and the information of the color difference between the image formed on the recording medium and the base image are accumulated. The terminal device 10 may calculate the color difference of when image formation is performed with the number of copies included in the request of the user from the relationship between the accumulated number and the color difference and may select the image forming apparatus that matches the color difference level requested by the user when image formation is performed with the number of copies included in the request of the user. In addition, in this configuration, the recording medium may be divided into one or more areas, and a color difference may be inspected in each area. Then, the information of the number of recording media and the information of the color difference between the image formed on the recording medium and the base image may be accumulated for each area. In the case of this configuration, the color difference of when image formation is performed with the number of copies included in the request of the user may be calculated in the area specified by the user from the relationship between the accumulated number and the color difference, and the image forming apparatus that matches the color difference level requested by the user when image formation is performed with the number of copies included in the request of the user may be selected.

In the exemplary embodiment above, a period of time until the image of the document is to be formed may be set in the screen of FIG. 12. In the case of this configuration, for example, the server apparatuses 20A to 20C transmit to the terminal device 10 information that represents the operation schedule of the connected image forming apparatus. The terminal device 10 may refer to the information representing the operation schedule and may select the image forming apparatus that may perform image formation until the period of time that the user inputs.

In the exemplary embodiment above, the server apparatus is connected to each of the image forming apparatuses. However, the invention is not limited to this configuration. For example, a configuration may be provided in which the image forming apparatuses 30A to 30C and the inspection devices 40A to 40C are connected to the server apparatus 20A.

In the exemplary embodiment above, the terminal device 10 selects the image forming apparatus that is to form the image of the document. However, the invention is not limited to this configuration.

For example, in the case of the configuration in which the image forming apparatuses 30A to 30C and the inspection devices 40A to 40C are connected to the server apparatus 20A, the terminal device 10 transmits the input request of the user and the document data selected by the user to the server apparatus 20A.

The server apparatus 20A evaluates the quality of the image formed by the image forming apparatuses 30A to 30C by using the quality information obtained from the inspection devices 40A to 40C and selects the image forming apparatus that matches the request transmitted from the terminal device 10.

The server apparatus 20A, when selecting the image forming apparatus that matches the request of the user, transmits the image data of the raster image of the document represented by the obtained document data and the request information representing the input request of the user to the selected image forming apparatus and instructs the selected image forming apparatus to perform image formation. That is, the server apparatus 20A which is an example of the information processing apparatus performs the same operation as the terminal device 10 and selects the image forming apparatus. According to this configuration, the amount of communication between the server apparatus and the terminal device decreases because the status information and the quality information are not transmitted to the terminal device 10.

In the exemplary embodiment above, the inspection device inspects the image formed on the recording medium. However, the invention is not limited to this configuration. For example, the inspection devices 40A to 40C may display the read image on the touch panel 403, perform sensory inspection on the displayed image, and allow the user to input the inspection result on the touch panel 403. In addition, for example, some items of the inspection of the image formed on the recording medium may be performed by the inspection devices 40A to 40C, and other items may be performed through sensory evaluation by the operator of the inspection device. For example, a color difference may be inspected by the inspection devices 40A to 40C. Image loss may be inspected through sensory evaluation by the operator of the inspection devices 40A to 40C, and the inspection result may be input by the operator into the inspection devices 40A to 40C.

In the exemplary embodiment above, the inspection devices 40A to 40C inspect loss, blur, and addition as image defects. However, defects to be inspected are not limited to these. For example, the inspection devices 40A to 40C may inspect vertical streaking that is present on the read paper, inspect the level of vertical streaking according to the thickness, concentration, and the like of the vertical

35 streaking, and transmit the quality information representing the inspection result to the server apparatus. In addition, the inspection devices 40A to 40C may inspect banding that is present on the read paper, inspect the level of banding according to the concentration difference between the part where concentration is high and the part where concentration is low, and transmit the quality information representing the inspect ion result to the server apparatus.

In the case of this configuration, when the items for setting the level of vertical streaking and the level of horizontal streaking are disposed in the screen on which the request of the user is input, the terminal device 10 selects the image forming apparatus that matches the level of vertical streaking and the level of horizontal streaking requested by the user.

In the exemplary embodiment above, the inspection devices 40A to 40C may divide the image of the read paper into one or more areas, inspect a color difference and image defects in each area, associate information representing the area with the quality information representing the result of inspection of each area, and store the associated information and the quality information on the server apparatus.

In addition, in this configuration, an area may be selected from one or more areas, and the color difference level and the image defect level requested by the user may be set for the selected area.

According to this configuration, the image forming apparatus that has the color difference level and the image defect level satisfying the request of the user in the area specified by the user is selected, and image formation is performed by the selected image forming apparatus. When, for example, the image represented by the document data is an image of a credit card statement, and an image has a defect in the area where an image of amount numbers is formed, the amount may not be reported correctly. In this case, when the image defect level is strictly set for the area where the image of amount numbers is formed, the image forming apparatus that forms an image exactly as the document data is selected, and the image of the statement is formed.

In addition, when, for example, the image represented by the document data is an image of a pamphlet of products, and the color of the image differs from the base image in the area where an image of a product is formed, the product is introduced in a different color from the actual product. In this case, when the color difference level is strictly set for the area where the image of the product is formed, the image forming apparatus that forms an image exactly as the document data is selected, and the image of the pamphlet in which the color of the actual product is reproduced is formed.

In the exemplary embodiment above, the inspection devices 40A to 40C determine the color difference ΔE. However, the inspection devices 40A to 40C may inspect not only the color difference ΔE but also ΔL*, Δa*, and Δb* in the color space of the L*a*b* color model. ΔL* is the difference of L* between the color of the raster image in the color space of the L*a*b* color model and the color of the image formed on the recording medium. Δa* is the difference of a* between the color of the raster image in the color space of the color model and the color of the image formed on the recording medium. Δb* is the difference of b* between the color of the raster image in the color space of the L*a*b* color model and the color of the image formed on the recording medium.

The inspection devices 40A to 40C inspect ΔL*, Δa*, and Δb* and transmit the quality information representing the inspection result to the server apparatus. The server apparatuses 20A to 20C transmit the result of inspection of ΔL*, Δa*, and Δb* obtained from the inspection device to the terminal device 10 in addition to the color difference ΔE obtained from the inspection device.

In the case of this configuration, for example, a GUI for inputting the levels of ΔL*, Δa*, and ←b* may be disposed in the screen on which the request of the user is input in addition to a GUI for inputting the level of the color difference ΔE. In this case, the terminal device 10 evaluates ΔL*, Δa*, and Δb* in the same manner as the color difference ΔE for each image forming apparatus.

According to this configuration, when, for example, the color in the direction of the a* axis is considered to foe important in the request of the user, the terminal device 10 excludes the image forming apparatus having poor reproducibility in the direction of the a* axis from the target of selection.

In the exemplary embodiment above, a configuration is provided in which the user sets desired quality of a color difference and image defects. However, when the image of the document is a binary image, the image forming apparatus may be selected by using the quality information related to image defects without setting a color difference.

In the exemplary embodiment above, a configuration is provided in which one image forming apparatus is selected from three image forming apparatuses. However, the number of image forming apparatuses included in the system may be one. When one image forming apparatus is provided and matches the request of the user (YES in step SA5), the document data and the input request of the user may be transmitted to the server apparatus (step SA7). As such, when one image forming apparatus is included in the system, and a determination is made as YES in step SA5, the flow of processes may transition to step SA7 without passing through step SA6 and step SA8. In this case, processes are simplified by the amount of processes of step SA6 and step SA8 that the flow of processes does not pass through. Thus, a period of time until the document data and the request of the user are transmitted is shortened. When the image forming apparatus does not match the request of the user (NO in step SA5), a message that prompts the user to review changing the request such as discarding the request is displayed (step SA9).

Each function realized in the above exemplary embodiment and in the modification example may be realized by one or more hardware circuits, may be realized by a CPU executing one or more programs, or may be realized by a combination thereof. When the above functions are realized by using a program, the program may be provided after being stored on a computer-readable recording medium such as a magnetic recording medium (a magnetic tape, a magnetic disk (a hard disk drive (HDD), a flexible disk (FD), and the like)), an optical recording medium (an optical disc and the like), a magneto-optical recording medium, and a semiconductor memory, or the program may be distributed through a communication line.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to under stand the invention for various embodiments and with the various modifications as are suited to the particular use contemplated. It is intended that the scope of the invention be defined by the following claims and their equivalents.

What is claimed is:

1. An image forming system comprising:
one or more image forming apparatuses, each of which including
an image data obtaining unit that obtains image data, and
a forming unit that forms an image on a recording medium, in which the image is represented by the image data obtained by the image data obtaining unit;
a quality information outputting device that is provided in each of the image forming apparatuses, including
an outputting unit that outputs quality information which represents quality of the image formed on the recording medium; and
an information processing apparatus including
a quality information obtaining unit that obtains the qualify information which the outputting unit outputs,
a request information obtaining unit that obtains request information which represents quality requested by a user with respect to the image formed on the recording medium,
a selecting unit that selects the image forming apparatus in which the quality information outputting device which outputs the quality information satisfying the quality represented by the request information is provided, and
an image data transmitter that transmits the image data to the image forming apparatus which the selecting unit selects.

2. The image forming system according to claim 1, wherein
the quality information outputting device further includes
a reading unit that reads the image formed on the recording medium by the forming unit, and
an inspector that inspects quality of the image formed on the recording medium based on the image data obtained by the image data obtaining unit and the image read by the reading unit, and
the outputting unit outputs quality information that represents quality obtained by the inspector.

3. The image forming system according to claim 2, wherein
the quality that the inspector inspects is a color difference between the image data obtained by the image data obtaining unit and the image read by the reading unit with respect to the image formed on the recording medium.

4. The image forming system according to claim 2, wherein
the quality that the inspector inspects is an image defect.

5. The image forming system according to claim 2, wherein
the inspector inspects quality for each of a plurality of areas into which the image read by the reading unit is divided,
the outputting unit outputs the quality information for each of the areas,
the request information includes area information that represents an area specified by a user with respect to the image formed on the recording medium, and
the selecting unit selects the image forming apparatus in which the quality information outputting device which outputs the quality information satisfying the quality represented by the request information with respect to the area represented by the area information is provided.

6. The image forming system according to claim 2, wherein
the recording medium on which the image is formed by the forming unit is transported to the quality information outputting device, and
the reading unit reads the image on the transported recording medium.

7. The image forming system according to claim 2,
wherein the selecting unit selects the image forming apparatus so that a level as which the quality information is classified matches a level as which the request information is classified.

6. An information processing apparatus comprising:
a quality information obtaining unit that obtains quality information from a quality information outputting device that is provided in each of one or more image forming apparatuses and outputs quality information which represents quality of an image formed on a recording medium by the image forming apparatus;
a request information obtaining unit that obtains request information which represents quality requested by a user with respect to the image formed on the recording medium;
a selecting unit that selects the image forming apparatus in which the quality information outputting device which outputs the quality information satisfying the quality represented by the request information is provided; and
an image data transmitter that transmits image data to the image forming apparatus which the selecting unit selects.
